(19) United States
(12) Patent Application Publication
(10) Pub. No.: US 2009/0278090 A1
(43) Pub. Date: Nov. 12, 2009

(54) LOW TEMPERATURE IRREVERSIBLE THERMOCHROMIC COMPOSITIONS

(76) Inventors: Brett L. Lucht, Kingston, RI (US); William B. Euler, Narrangansett, RI (US)

Correspondence Address: PERKINS COIE LLP, POST OFFICE BOX 1208, SEATTLE, WA, 98111-1208, US

(21) Appl. No.: 12/437,473

(22) Filed: May 7, 2009

Related U.S. Application Data
(60) Provisional application No. 61/051,150, filed on May 7, 2008.

(51) Int. Cl. G01N 31/22; C08G 75/06; C08L 81/02; C08L 77/00; C08L 67/00

(52) U.S. Cl. 252/408.1; 528/380; 525/186; 525/535; 524/502; 524/538; 524/539

(57) ABSTRACT

Provided herein are novel polythiophene compounds having polyalkoxyl sidechains and low temperature irreversible upon activation (IUA) thermochromic compounds/compositions thereof. The IUA thermochromic compounds or compositions are activated and exhibit an IUA color by heating to or above a reversible thermochromic transition temperature (RTTT) and cooling to or below an irreversible thermochromic transition temperature (IRTTT) in less than 2 seconds. The activated IUA thermochromic compounds or compositions will retain their IUA color as long as the compounds or compositions are kept at or below about 5° C. below the IRTTT. The activated IUA thermochromic compounds or compositions will be deactivated and show a different color upon exposure to a temperature equal to or higher than about 5° C. below the IRTTT unless the compounds or compositions are activated again. The IUA thermochromic compounds/composition can be used to prepare IUA thermochromic indicators which can monitor subjects stored below a pre-determined temperature and detect the subjects that have been exposed to a temperature above the pre-determined temperature.

### RELATED APPLICATIONS

The present application claims priority to U.S. Provisional Patent Application No. 61/051,150, filed May 7, 2008, the disclosure of which is incorporated by reference herein in its entirety.

### STATEMENT REGARDING FEDERALLY SPONSORED RESEARCH OR DEVELOPMENT

The invention is sponsored by US Army/Natick with Project Number 500-2103-0000-0001326. The U.S. Government has a paid-up license in this invention and the right in limited circumstances to require the patent owner to license others on reasonable terms as provided for by the terms of FY01-PS10 awarded by USDOT.

### FIELD OF THE INVENTION

The present invention relates to thermochromic compounds, inks, compositions and methods thereof.

### BACKGROUND

Maintaining proper handling and storage temperature of food products is an important aspect of food safety. At a recent symposium sponsored by the Food Safety and Inspection Service (FSIS) of the U.S. Department of Agriculture it was disclosed that 76 million Americans reported having a food borne illness each year. In addition, 1 in 1000 people are hospitalized each year with food borne illnesses. These health problems result in over $6.5 Billon in medical expenses. Of the over 2,700 cases reported to the Centers for Disease Control (CDC) between 1993 and 1997, 73% were the result of improper holding conditions of the food products. Therefore, there is a need to develop an easily integrated, computer monitored, low-cost, track and trace temperature monitoring system for food products.

Thermochromic material has been used in time-temperature indicators (TTIs). Currently available time-temperature indicators are derived from one of three types of materials: the time-dependent diffusion of dyed fatty esters through porous material; controlled enzymatic hydrolysis of lipids; and solid state polymerization of uncolored acetylenic monomers that produce highly colored polymers. These TTIs are designed as visually retrievable sensors of the shelf life of products, and provide a good correlation to microbial growth. However, the cost of TTIs is high and there is no automated method to track and trace standard TTIs. The colorants currently utilized in TTIs require macro-encapsulation and can not be readily incorporated into standard ink formulations for TTI. Thus, it would be prohibitively expensive and inconvenient to create a TTIs, which may be bar codes or other indicia, using existing technology.

Development of pigments which can be used in TTI (e.g. bar codes) allows for the creation of an inexpensive and computer verified track and trace system that continuously monitors the temperature of food products. At any point during storage, transport, or distribution of food products the TTI can be scanned to determine that proper holding temperatures have been maintained. Improper storage temperatures will be indicated by a change in the TTI allowing the product to be removed from the food chain to protect the consumer.

Currently available low temperature thermochromic inks are reversible thermochromic inks and cannot be used to continuously and reliably monitor food products in the cold chain during transportation and storage. A reversible thermochromic ink will change color from a first color to a second color when the temperature of the ink meets or exceeds a transition temperature. However, when the ink is cooled from a temperature at or above the transition temperature to below the transition temperature, the ink will change from the second color to the first color. A TTI derived from a reversible thermochromic ink can detect a food product that is presently at or above the transition temperature of the reversible thermochromic ink, but cannot detect a food product that has met or exceeded the transition temperature in the past while it is currently below the transition temperature. Therefore, reversible low temperature thermochromic inks cannot be used to continuously and reliably monitor food products in the cold chain, and there is a need for irreversible low temperature thermochromic ink that can be used in a thermally sensitive TTI to monitor individual food packages in the cold chain during transportation and storage.

### SUMMARY

One embodiment provides a polythiophene compound that has the chemical structure:

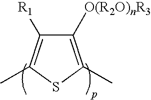

including stereoisomers thereof, wherein:

each R₁ of each monomer is independently selected from the group consisting of H, alkyl radical and alkoxyl radical; each R₂ and R₃ of each monomer is independently selected from the group consisting of alkyl radical and alkoxyl radical; each n of each monomer is an integer selected independently; and p is 2-1000.

In certain embodiments, the polythiophene compound is an irreversible upon activation (IUA) thermochromic compound.

In another aspect, a composition comprising a compound having Structure I is an irreversible upon activation (IUA) thermochromic composition.

In certain embodiments, an IUA thermochromic composition has an irreversible thermochromic transition temperature (IRTTT) between about −30° C. to about 60° C.

Another aspect relates to an IUA thermochromic indicator comprising an IUA thermochromic component prepared using an IUA thermochromic composition, wherein the deactivation of the activated IUA thermochromic composition is detectable.

Another aspect relates to a method of preparing an activated IUA thermochromic composition comprising: converting the IUA thermochromic composition to a high temperature state of the IUA thermochromic composition; and cooling the IUA thermochromic composition from the high temperature state to a cooling temperature in a cooling time.

In certain embodiments, an IUA thermochromic composition is converted to a high temperature state by exposure to high radiant energy (e.g. UV light).

An IUA thermochromic composition may also be converted to a high temperature state by being heated to a heating temperature for a time sufficient to display a high temperature color. In certain embodiments, a heating temperature is at or above a RTTT of an IUA thermochromic composition. In certain embodiments, a heating temperature is 20° C. below a RTTT of an IUA thermochromic composition.

In certain embodiments, a cooling temperature is about 5-20° C. below an IRTTT of an IUA thermochromic composition. In certain embodiments, a cooling temperature is more than 20° C. below an IRTTT of an IUA thermochromic composition. In certain embodiments, a cooling temperature is more than 30° C. below an IRTTT of an IUA thermochromic composition. In certain embodiments, a cooling time is in less than about 2 seconds. A cooling time may also be less than about 1 second.

In certain embodiments, an IUA thermochromic indicator may be made by a method comprising an IUA thermochromic component prepared using an IUA thermochromic composition comprising applying the IUA thermochromic composition to an article in a certain pattern and activating the IUA thermochromic composition, wherein the certain pattern is designed to show deactivation of the activated IUA thermochromic composition.

Another aspect relates to monitoring subjects stored in the absence of a pre-determined condition comprising applying an activated IUA thermochromic indicator to the subjects and detecting the deactivated IUA thermochromic indicator of the subjects which are or have been exposed to the pre-determined condition.

In certain embodiments, a pre-determined condition is a temperature-related pre-determined condition. In certain embodiments, a temperature-related pre-determined condition is exposure to a pre-determined temperature for a pre-determined time period.

### BRIEF DESCRIPTION OF THE FIGURES

FIG. 1. Spectroscopic analysis of poly(3-methyl-4-polyoxyethylene(2) stearyl ether thiophene) (PMOE-2-SET).

FIG. 2. Spectroscopic analysis of poly(3-methyl-4-polyoxyethylene(4) lauryl ether thiophene) (PMOE-4-LET).

FIG. 3. Spectroscopic analysis of 50:50 MOE-2-SET:MOE-4-LET Copolymer-1.

FIG. 4. Spectroscopic analysis of 75:25 MOE-2-SET:MOE-4-LET Copolymer-2.

FIG. 5. Spectroscopic analysis of 25:75 MOE-2-SET:MOE-4-LET Copolymer-3.

FIG. 6A. An IUA thermochromic indicator comprising a Purveyor's bar code and a selectively-readable indicium prior to exposure to a pre-determined condition.

FIG. 6B. An IUA thermochromic indicator comprising a Purveyor's bar code and a selectively-readable indicium after exposure to a pre-determined condition.

FIG. 7A. An IUA thermochromic indicator adopting a GILBAR™ two bar code structure prior to exposure to a pre-determined condition.

FIG. 7B. An IUA thermochromic indicator adopting a GILBAR™ two bar code structure after exposure to a pre-determined condition.

FIG. 8A. An IUA thermochromic indicator comprising human recognized indicia and machine recognized bar code prior to exposure to a pre-determined condition.

FIG. 8B. An IUA thermochromic indicator comprising human recognized indicia and machine recognized bar code after exposure to a pre-determined condition.

FIG. 9. An IUA thermochromic indicator comprising a first selectively-unreadable always-readable indicium and multiple selectively-readable indicia for respectively identifying one or multiple pre-determined conditions the indicator is or has been exposed to.

FIG. 10. An IUA thermochromic indicator using a single coded indicia for identifying more than one pre-determined conditions the indicator is or has been exposed to.

FIG. 11. An IUA thermochromic indicator comprising a two-dimension code.

FIG. 12. A CC-A code using Composite Component structures.

### DETAILED DESCRIPTION

### 1. Structure of the Polythiophene Compounds.

A novel polythiophene compound has the following Structure I:

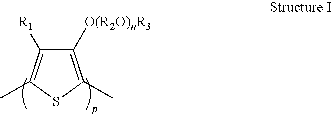

including stereoisomers thereof.

As used herein, unless otherwise specified, each R₁ of each monomer is independently selected from the group consisting of H, alkyl radical and alkoxyl radical;

each R₂ of each monomer is independently selected from the group consisting of alkyl radical and alkoxyl radical;

each R₃ of each monomer is independently selected from the group consisting of alkyl radical and alkoxyl radical;

each n of each monomer of a polythiophene is an integer selected independently; and

p is an integer.

In certain embodiments, n is selected from 0 to 100; in certain embodiments, n is selected from 0 to 15; in certain embodiments, n is selected from 0 to 6; in certain embodiments, n is selected from 1 to 15; in certain embodiments, n is selected from 1 to 6. In certain embodiments, p is 1-1000; in certain embodiments, p is 2-1000; in certain embodiments, p is 1-500; in certain embodiments, p is 2-500; in certain embodiments, p is 1-100; in certain embodiments, p is 2-100; in certain embodiments, p is 10-100.

As used herein, the term “alkyl radical” means a branched or unbranched, saturated or unsaturated, monovalent or multivalent hydrocarbon group. Examples of alkyl include, but are not limited to, methyl, ethyl, propyl, isopropyl, butyl, isobutyl, t-butyl, pentyl, hexyl, heptyl, octyl, nonyl, decyl, undecyl, dodecyl, ethenyl, propenyl, butenyl, isobutenyl, pentenyl, hexenyl, heptenyl, octenyl, nonenyl, decenyl, undecenyl, dodecenyl, ethynyl, propynyl, butynyl, isobutynyl, pentynyl, hexynyl, heptynyl, octynyl, nonynyl, decynyl, undecynyl, dodecynyl, methylene, ethylene, propylene, isopropylene, butylene, isobutylene, t-butylene, pentylene, hexylene, heptylene, octylene, nonylene, decylene, undecylene and dodecylene. In certain embodiments, the hydrocarbon group contains 1 to 20 carbons. In certain embodiments, the hydrocarbon group contains 1 to 30 carbons. In certain embodiments, the hydrocarbon group contains 3 to 50 carbons.

As used herein, unless specified otherwise, the term “alkoxyl” means an alkyl, cycloalkyl or heterocycloalkyl, which further contains one or more oxygen atoms. Examples of alkoxyl include, but are not limited to, —CH₂—OH, —OCH₃, —O-alkyl, -alkyl-OH, -alkyl-O-alkyl-, wherein the two alkyls can be the same or different.

As used herein, unless specified otherwise, the term “cycloalkyl” means an alkyl which contains at least one ring and no aromatic rings. Examples of cycloalkyl include, but are not limited to, cyclopropyl, cyclobutyl, cyclopentyl, cyclohexyl, cycloheptyl, cyclooctyl, cyclononyl, cyclodecyl, cycloundecyl and cyclododecyl. In certain embodiments, the hydrocarbon chain contains 3 to 20 carbons. In certain embodiments, the hydrocarbon group contains 3 to 30 carbons.

As used herein, unless specified otherwise, the term “heterocycloalkyl” means a cycloalkyl wherein at least one ring atom is a non-carbon atom. Examples of the non-carbon ring atom include, but are not limited to, S, O and N.

In certain embodiments, a polythiophene compound has Structure I, including stereoisomers thereof, wherein R₁ is the same for each monomer and R₂ is the same for each monomer. In certain embodiments, R₁ is an alkyl radical containing 1 to 12 carbons. In certain embodiments, R₁ is methyl.

In certain embodiments, a polythiophene compound is a poly(3-methyl-4-polyoxyethylenealkylether)thiophenes (PMOET) having Structure II

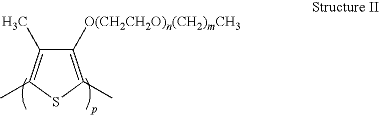

including stereoisomers thereof, wherein:

each m of each monomer of the polythiophene compound is an independently selected integer; the average of m of all monomers (“m”) is 7 to 21;

each n of each monomer of the polythiophene compound is an independently selected integer; the average of n of all monomers (“n”) is 0 to 6;

3n+m+1 is 20 to 40; a

p is an independently selected integer.

In certain embodiments, a polythiophene compound has Structure II, including stereoisomers thereof, wherein m is 17 and the average of n is 2 (“PMOE-2-SET”), and the corresponding monomer is MOE-2-SET.

In certain embodiments, a polythiophene compound has Structure II, including stereoisomers thereof, wherein m is 11 and the average of n is 4 (“PMOE-4-LET”), and the corresponding monomer is MOE-4-LET.

In certain embodiments, a polythiophene compound has Structure II, including stereoisomers thereof, wherein the monomers are a mixture of MOE-2-SET (m is 17 and the average of n is 2) and MOE-4-LET (m is 11 and the average of n is 4).

### 2. Polythiophene Compositions

Another aspect of the invention relates to a polythiophene composition comprising a polythiophene compound having Structure I, Structure II, or a plural or a mixture thereof.

In certain embodiments, a polythiophene composition has Structure II, including stereoisomers thereof, wherein the monomers of all polymers contain 50% MOE-2-SET and 50% MOE-4-LET (Copolymer-1). In certain embodiments, a polythiophene composition has Structure II, including stereoisomers thereof, wherein the monomers of all polymers contain 75% MOE-2-SET and 25% MOE-4-LET (Copolymer-2). In certain embodiments, a polythiophene composition has Structure II, including stereoisomers thereof, wherein the monomers of all polymers contain 25% MOE-2-SET and 75% MOE-4-LET (Copolymer-3).

In certain embodiments, a polythiophene composition of the invention comprises a carrier medium and a polythiophene compound having Structure I, Structure II, or a plural or a mixture thereof. A concentration of the polythiophene compound(s) in the polythiophene composition is from about 0.05% to about 99.5% by weight. In certain embodiments, the concentration of polythiophene compound(s) in a polythiophene composition is from 0.05% to 25% by weight. In certain embodiments, the concentration of polythiophene compound(s) in a polythiophene composition is from 0.05% to 5% by weight. In certain embodiments, the concentration of polythiophene compound(s) in a polythiophene composition is 10% by weight.

As used herein, the term “carrier medium” means a material, composition or a formula, such as liquid or solid solvent, diluent. Examples of carrier medium include, without limitation, polyurethanes; elastomers including polysiloxanes and polydienes; polyacrylates, poly(ethylene terephthalate)s (PET), polystyrenes, polyolefins including polyethylenes (HDPE and LDPE) and polypropylene, polycarbonates, polyacrylics, polyacrylic acids, polyacrylamides, polymethacrylics, polyvinyl ethers, polyvinyl halides, poly(vinyl nitrile)s, polyvinyl esters, polyesters, polysofones, polysulfonamides, polyamides, polyimines, polyimides, and carbohydrates.

In certain embodiments, a carrier medium comprises an ink formulation, wherein the ink formulation comprises oils, resins, pigment extenders and additives.

In certain embodiments, a polythiophene composition of the invention is an irreversible upon activation (IUA) thermochromic composition.

As used herein, the term “thermochromic” means the ability of a composition to change color due to a change of temperature.

In certain embodiments, a polythiophene composition of the invention has a reversible thermochromic transition temperature (RTTT) determined by variable temperature reflection spectra, wherein the center of the sigmoid transition curve of the variable temperature spectra is the RTTT. The thermochromic transition is reversible. The polythiophene composition also has a low reversible thermochromic transition temperature (RTTT_{L}) determined by variable temperature reflection spectra, wherein the temperature at which the reversible thermochromic transition starts is the RTTT_{L}. The composition has a high temperature state and a low temperature state. At a temperature below the RTTT_{L}, the composition shows a low temperature color and is at a low temperature state. When the composition is heated to or above the RTTT_{L}, the composition shows a high temperature color and is at a high temperature state. This temperature-dependent color change is reversible because when the high temperature color composition is cooled to a temperature below the RTTT_{L}, the composition color will change back to the low temperature color.

In certain embodiments, a polythiophene composition has a high temperature color of yellow. In certain embodiments, a polythiophene composition has a low temperature color of burgundy or violet.

In certain embodiments, a RTTT_{L} is about 0.5-40° C. below the RTTT. In certain embodiments, a RTTT_{L} is about 5-20° C. below the RTTT. In certain embodiments, a RTTT_{L} is about 5-10° C. below the RTTT. In certain embodiments, a RTTT_{L} is about 0.5-5° C. below the RTTT.

In certain embodiments, a polythiophene composition of the invention has an irreversible thermochromic transition temperature (IRTTT) determined by variable temperature reflection spectra, wherein the center of a sigmoid transition curve of the variable temperature spectra is the IRTTT. The thermochromic transition is irreversible. The polythiophene composition also has a low irreversible thermochromic transition temperature (IRTTT_{L}) determined by variable temperature reflection spectra, wherein the temperature at which the reversible thermochromic transition starts is the IRTTT_{L}. Such a composition is also referred to as an irreversible upon activation (IUA) thermochromic composition. In certain embodiments, an IRTTT_{L} is about 0.5-40° C. below the IRTTT. In certain embodiments, an IRTTT_{L} is about 5-20° C. below the IRTTT. In certain embodiments, an IRTTT_{L} is about 5-10° C. below the IRTTT. In certain embodiments, an IRTTT_{L} is at about 0.5-5° C. below the IRTTT.

As used herein, an IUA thermochromic composition has a RTTT, a RTTT_{L}, a high temperature state and color, and a low temperature state and color as defined supra. The IUA thermochromic composition further has an IRTTT, an IRTTT_{L} and a metastable state (activated state) and shows an IUA color at the activated state. Both the low temperature state and the high temperature state are referred to as deactivated states, the low temperature state is a deactivated low state and the high temperature state is a deactivated high state. In certain embodiments, an IUA thermochromic composition has a high temperature color of yellow. In certain embodiments, an IUA thermochromic composition has a low temperature color burgundy or violet. In certain embodiments, an IUA thermochromic has an IUA color of pink or orange.

The process by which an IUA thermochromic composition is converted from a deactivated state to an activated state is called “activation.” An IUA thermochromic composition at an activated state is called an “activated” IUA thermochromic composition. In certain embodiments, an IUA thermochromic composition is activated by converting the IUA thermochromic composition to a high temperature state and then cooling the IUA thermochromic composition rapidly enough to an activated state. An activated IUA thermochromic composition will retain an IUA color as long as the composition is kept below an IRTTT.

The process by which an IUA thermochromic composition is converted from an activated state to a deactivated state is called deactivation. An IUA thermochromic composition at a deactivated state is called a “deactivated” IUA thermochromic composition. An activated IUA thermochromic composition will be deactivated and change color from an IUA color to a low temperature color when the IUA thermochromic composition is heated to or above an IRTTT_{L} but below a RTTT_{L}. The deactivated IUA thermochromic composition is now at a deactivated low state. This temperature-dependent color change is irreversible because when the deactivated IUA thermochromic composition is cooled from the deactivated low state to or below the IRTTT_{L}, the IUA thermochromic composition will retain the low temperature color, remain deactivated and will not change back to the IUA color. An activated IUA thermochromic composition will be deactivated and change color from an IUA color to a high temperature color when the composition is heated to or above a RTTT_{L}. The IUA thermochromic composition is now at a deactivated high state. This temperature-dependent color change is also irreversible when the deactivated IUA thermochromic composition is cooled from the deactivated high state to or below the IRTTT_{L} without re-activating the IUA thermochromic composition. The IUA thermochromic composition will change to the low temperature color, remain deactivated and will not change back to the IUA color.

In certain embodiments, an IUA thermochromic composition has an IRTTT between about −30° C. to about 60° C. In certain embodiments, an IUA thermochromic composition has an IRTTT between about −20° C. to about 20° C. In certain embodiments, an IUA thermochromic composition has an IRTTT of −20° C., −18° C., −12° C., −6° C., 5° C. or 18° C. In certain embodiments, an IUA thermochromic composition is a PMOE-4-LET and has an IRTTT of 5° C. In certain embodiments, an IUA thermochromic composition is a PMOE-2-SET and has an IRTTT of 18° C. In certain embodiments, an IUA thermochromic composition is a 50:50 MOE-4-LET:MOE-2-SET Copolymer-1 and has an IRTTT of −18° C. In certain embodiments, an IUA thermochromic composition is a 75:25 MOE-4-LET:MOE-2-SET Copolymer-2 and has an IRTTT of −6° C. In certain embodiments, an IUA thermochromic composition is a 25:75 MOE-4-LET:MOE-2-SET Copolymer-3 and has an IRTTT of −20° C.

In certain embodiments, an IUA thermochromic composition is activated by converting the IUA thermochromic composition to a high temperature state and cooling the composition to a cooling temperature in a cooling time.

In certain embodiments, an IUA thermochromic composition is converted to a high temperature state by exposure to high radiant energy (e.g. UV light). In certain embodiments, an IUA thermochromic composition is converted to a high temperature state by exposure to heat.

In certain embodiments, an IUA thermochromic composition is converted to a high temperature state by heating the IUA thermochromic composition to a heating temperature for a heating time sufficient to display a high temperature color. As used herein, the term “heating temperature” means a temperature to which an IUA thermochromic composition is raised. In certain embodiments, a heating temperature is a temperature at or above a RTTT_{L}. In certain embodiments, a heating temperature is 20° C. below a RTTT of an IUA thermochromic composition. In certain embodiments, a heating temperature is a temperature at which an IUA thermochromic composition exhibits a high temperature color in less than about 1 minute. In certain embodiments, a heating temperature is between 80 and 150° C. In certain embodiments, a heating time is between 0.5 and 4 seconds.

As used herein, the term “cooling temperature” means a temperature to which an IUA thermochromic composition is cooled. In certain embodiments, a cooling temperature is a temperature below an IRTTT_{L} of an IUA thermochromic composition. In certain embodiments, a cooling temperature is about 5-20° C. below an IRTTT. In certain embodiments, a cooling temperature is more than 20° C. below an IRTTT. In certain embodiments, a cooling temperature is more than 30° C. below an IRTTT.

As used herein, the term “cooling time” means a time period when an IUA thermochromic composition is cooled from a heating temperature to a cooling temperature. In certain embodiments, a cooling time is less than about 2 seconds. In certain embodiments, a cooling time is less than about 1 second.

In certain embodiments, an IUA thermochromic composition is activated using a thermochromic ink label activator as described in patent application Ser. No. 12/428,323, filed on Apr. 22, 2009, the disclosure of which is herein incorporated by its entirety. The thermochromic ink label activator includes a first stage activation energy source and a second stage rapid label cooling unit. The first stage activation energy source may include a radiant illumination unit, such as a UV or IR lamp. It may also instead include a contact hot plate or hot air source to help cause rapid absorption of energy into the IUA thermochromic composition. The rapid cooling unit may include a cold plate moving into momentary physical contact with the IUA thermochromic composition to cool the high temperature state IUA thermochromic composition to an IUA state.

### 3. IUA Thermochromic Indicator

Another aspect of the invention relates to an IUA thermochromic indicator comprising at least one IUA thermochromic component prepared using an IUA thermochromic composition. The terms relating to the thermochromic properties of an IUA thermochromic composition (e.g. “activation,” “activated,” “deactivation,” “deactivated,” “IUA color,” “RTTT,” “IRTTT,” “RTTT_{L},” “IRTTT_{L}”) are defined the same as supra when applied to or associated with an IUA thermochromic component and an IUA thermochromic indicator. For example, an IUA thermochromic component has the same RTTT/RTTT_{L} or IRTTT/IRTTT_{L} as that of the IUA thermochromic composition. An IUA thermochromic component is activated/deactivated when the IUA thermochromic composition it is made of is activated/deactivated.

An IUA thermochromic component or indicator is activated before it is put in use. Therefore, the activated IUA thermochromic component or indicator will remain activated in the absence of a pre-determined condition and become deactivated upon exposure to the pre-determined condition. As used herein, the deactivation process of an activated IUA thermochromic component or indicator upon exposure to a pre-determined condition is called “triggering,” and the deactivated IUA thermochromic component or indicator is “triggered.”

In certain embodiments, a pre-determined condition is a temperature-related pre-determined condition. In certain embodiments, a temperature-related pre-determined condition comprises exposure to a pre-determined temperature/temperature range for a pre-determined time period. In certain embodiments, for different pre-determined temperature/temperature range, the pre-determined time period may be different. For example, a temperature-related pre-determined condition may comprise an exposure to 33-39° F. for more than 2 hours. The temperature-related pre-determined condition may further comprise an exposure to 40-75° F. for more than 1 hour. The temperature-related pre-determined condition may further comprise an exposure to a temperature that is at or above 90° F. for more than 5 minutes. Another example of a temperature-related pre-determined condition comprises an exposure to 10° C. for 2 hours, and/or an exposure to 15° C. for less than 1 minute.

In certain embodiments, a pre-determined temperature is +/—O—20° C. of an IRTTT of an IUA thermochromic composition. In certain embodiments, a pre-determined temperature is +/−0-10° C. of an IRTTT of an IUA thermochromic composition. In certain embodiments, a pre-determined temperature is +/—O—5° C. of an IRTTT of an IUA thermochromic composition. In certain embodiments, a pre-determined time is selected from 1 sec to 20 hours.

In certain embodiments, an IUA thermochromic component is designed such that it is invisible or undetectable when it is activated and becomes visible or detectable when it is triggered upon exposure to a pre-determined condition.

As used herein, the term “invisible” means a subject is invisible to a human eye or not recognizable by a scanning or detecting device, wherein the subject can be a pattern; the term “visible” means visible to a human eye or recognizable by a scanning or detecting device. For example, an IUA thermochromic component may remain “visible” to human eyes by always showing a color regardless of the exposure to a pre-determined condition. However, it may not be visible when the IUA thermochromic component is scanned by a pre-determined wavelength. For example, an activated IUA thermochromic component made of an IUA thermochromic POMET (e.g. PMOE-2-SET, PMOE-4-LET or a copolymer thereof) or a composition thereof may be transparent/invisible when scanned under 650 nm. However, the IUA thermochromic component will become visible under 650 nm when it is deactivated. Therefore, the IUA thermochromic component will have a pattern “appear” after it is triggered upon exposure to a pre-determined condition. Based on the same principles, an IUA thermochromic component may be designed to “disappear” after being trigged upon exposure to a pre-determined condition. For example, in the activation process as described supra, instead of activating the whole IUA thermochromic component by rapid cooling from its high temperature state, only part of the IUA thermochromic component can be activated to form a pattern (e.g. a dot in a square, or a word such as “NOT”) which will be invisible or “disappear” when it is triggered. In certain embodiments, a chilling press engraved with a desired pattern can be pressed on an IUA thermochromic component that is in its high temperature state. The part of the IUA thermochromic component that has contact with the chilling press will be cooled rapidly and become activated. The part of the IUA thermochromic component that has no contact with the chilling press will be cooled slowly and remain deactivated. Because of the different visibility or readability of the activated and deactivated IUA thermochromic composition, the pattern is “visible” to human eyes or a scanning or detecting device in the absence of a pre-determined condition. However, after exposure to the pre-determined condition, the activated part of the IUA thermochromic component will be deactivated and can no longer be differentiated from the deactivated part of the IUA thermochromic component. Therefore, the original visible pattern will be “invisible” and “disappear” and become invisible when the IUA thermochromic component is triggered.

In certain embodiments, an IUA thermochromic component is by itself an indicium the readability of which is changed after the IUA thermochromic component is triggered. In certain embodiments, an IUA thermochromic component is by itself an indicium and can form an indicium by associating with other component(s) the readability of which is (are) changed after the IUA thermochromic component is triggered. In certain embodiments, an IUA thermochromic component is not by itself an indicium but by associating with other component(s) forms an indicium the readability of which is changed after the IUA thermochromic component is triggered.

An indicium is a component or structure which may be identified or read by human, conventional scanner, optical scanner, computer or other automated identification and data capture methods, and is associated with a desired message or information. Examples of indicia include those known in the art, for example, Reduced Space Symbology (RSS, see GS1 website at http://www.gs1.org), UPC, JAN, EAN/UPC, GS1-128, ITF-14, Data matrix, Composite Component (CC), RRFID, Auto-ID, RFID, biometrics, magnetic stripes, OCR, smart cards, voice recognition, other identification, standard language system and platform provided locally, nationally, globally, and used by GS-1. Also included are indicia comprising human readable data combined with other readable indicia such as bar code data, RSS, UPC, EAN, UCC-13, GTIN, RFID, GILBAR™, or those comprising a component of the Food Sentinel System™.

In certain embodiments, an indicium can be identified or read due to its optical readability. The term “optical readability” is intended to cover all indicia that can be recognized by a human or optical scanning equipment such as scanners, cameras, and lasers. Examples of optically readable indicia include, without limitation, RSS, UPC, JAN, EAN/UPC, GS1-128, ITF-14, Data matrix and Composite Component (CC).

In certain embodiments, an IUA thermochromic indicator comprises an indicium that is identifiable or remains readable regardless of the presence or absence of a pre-determined condition (“always-readable indicium”). In certain embodiments, an IUA thermochromic indicator comprises an indicium that is readable in the absence of a pre-determined condition and unreadable after exposure to the pre-determined condition (“selectively-unreadable indicium”). In certain embodiments, an IUA thermochromic indicator comprises an indicium that is unreadable in the absence of a pre-determined condition and becomes readable after exposure to the pre-determined condition (“selectively-readable indicium”).

In certain embodiments, an always-readable component or indicium of an IUA thermochromic indicator includes product identifying information, source of manufacturer, source of distributor, or other information that is of use in tracking and tracing an item or is desired. In certain embodiments, an always-readable component or indicium of an IUA thermochromic indicator includes a two-dimensional structure such as a Composite Component structure.

In certain embodiments, a selectively-readable indicium of an IUA thermochromic indicator comprises an initially non-readable component and an IUA thermochromic component designed to identify the absence or presence of exposure to the indicator to a pre-determined condition. Upon exposing the indicator to the pre-determined condition, the IUA thermochromic component is triggered such that the initially non-readable component itself or by associating with the triggered IUA thermochromic component becomes a readable indicium (e.g. a readable bar code) identifying the product as having been exposed to the pre-determined condition. Upon such identification, the product is targeted for removal or culling from the distribution chain. In addition, the location and time of occurrence of presence of such product is marked and archived.

In certain embodiments, a selectively-readable indicium is an IUA thermochromic component, wherein the indicium is not readable in the absence of a pre-determined condition, and is triggered to become readable or identifiable after exposure to the pre-determined condition.

In certain embodiments, a selectively-unreadable indicium may include an initially readable component (e.g. a readable bar code) and an IUA thermochromic component designed to identify the absence or presence of exposure to a pre-determined condition. Upon exposure to the pre-determined condition, the IUA thermochromic component is triggered such that the triggered IUA thermochromic component by itself or by associating with the initially readable component becomes an unreadable indicium and therefore identify the product as having been exposed to the pre-determined condition. Upon such identification, the product is targeted for removal or culling from the distribution chain. In addition, the location and time of occurrence of presence of such product is marked and archived.

In certain embodiments, a selectively-nonreadable indicium is an IUA thermochromic component, wherein the indicium is readable in the absence of a pre-determined condition, and is triggered to become non-readable after exposure to the pre-determined condition.

In certain embodiments, an IUA thermochromic indicator comprises an always-readable indicium and a selectively-readable indicium. In certain embodiments, an IUA thermochromic indicator comprises an always-readable indicium and a selectively-nonreadable indicium. In certain embodiments, an IUA thermochromic indicator comprises a selectively-readable indicium and a selectively-nonreadable indicium. In certain embodiments, an IUA thermochromic indicator comprises an always-readable indicium, a selectively-readable indicium, a selectively-nonreadable indicium, a plurality or a mixture thereof.

In certain embodiments, an IUA thermochromic indicator comprises a paired bar code and printing structure associated with an IUA component wherein when the indicator is or has been exposed to a pre-determined condition the IUA component will change so that only an indicium indicating the exposure to the pre-determined condition will be readable. Such indicium may show or encode “do not sell” or “remove item from distribution.”

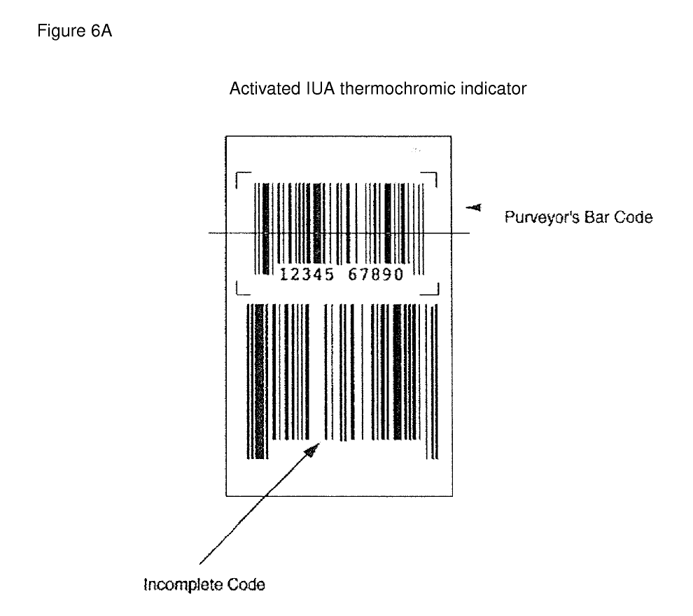

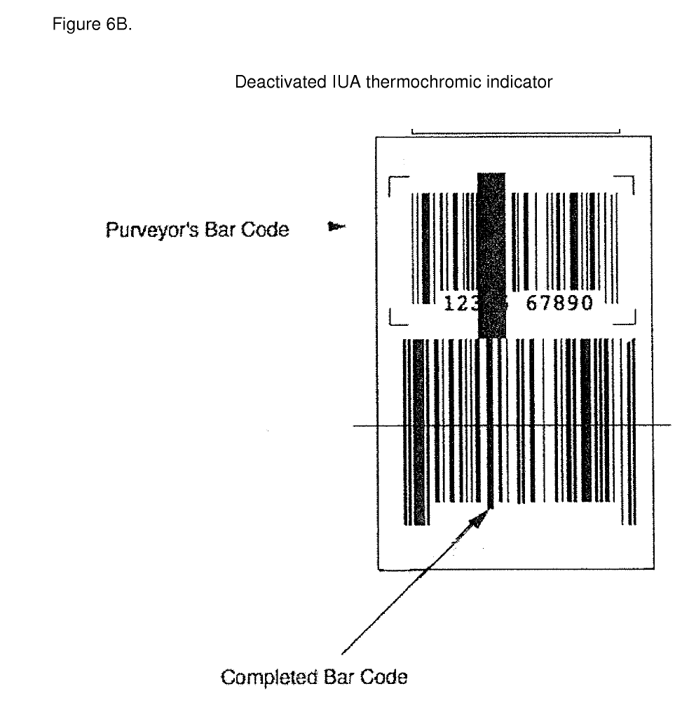

In certain embodiments, an IUA thermochromic indicator (FIGS. 6A and 6B) comprises two bar codes and an IUA thermochromic component. One of the bar code is associated with the IUA thermochromic component to form a selectively-nonreadable indicia (Purveyor's bar code, FIGS. 6A and 6B), and the other bar code is associated with the IUA thermochromic component to form a selectively-readable indicia (Incomplete Bar Code in FIG. 6A and Completed Bar Code in FIG. 6B). Each bar code is exclusively readable in the absence or present of a pre-determined condition. In the absence of the pre-determined condition, the selectively-nonreadable indicia will be recognized to provide product information or any information desired (e.g. “not contaminated”) and the selectively-readable indicia will not be recognized. After the exposure to the pre-determined condition, the selectively-nonreadable indicia will not be recognized to indicate the product information or any information as desired and the selectively-readable indicia will be recognized to indicate the exposure to the pre-determined condition (e.g. “contaminated” or “heated”). In certain embodiments, the IUA thermochromic indicator can further include an always-readable indicia to store product information or any other information as desired.

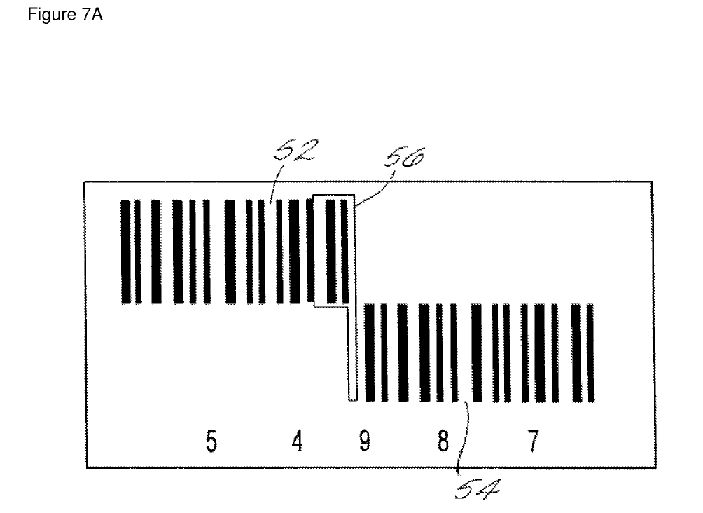

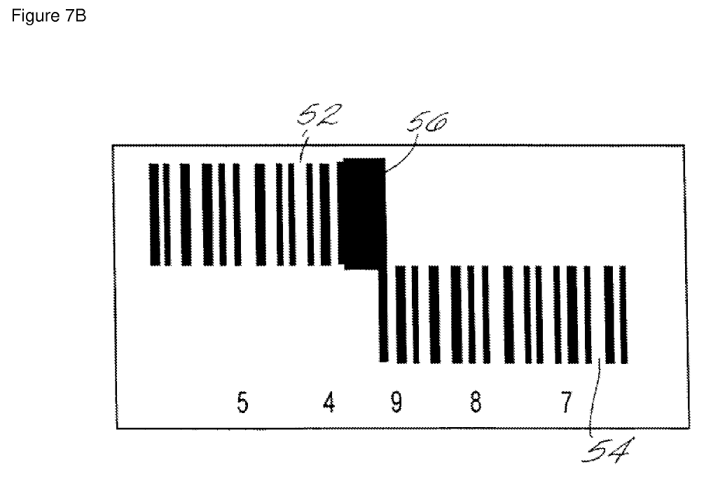

In certain embodiments, an IUA thermochromic indicator comprises two bar codes aligned as bar codes under the trademark GILBAR™ (FIGS. 7A and 7B): a product identification bar code (52, FIGS. 7A and 7B) which is a selectively-unreadable indicium; and a condition detecting bar code (54, FIGS. 7A and 7B) which is a selectively-readable indicium. An IUA thermochromic component (56, FIGS. 7A and 7B) is prepared using an IUA thermochromic composition. The IUA thermochromic component is outlined with black lines as shown in FIGS. 7A and 7B for ease in visualizing the invention. However, in practice, these lines are not present so there is no interference with a bar code scanner or reader's ability to recognize product identification bar code. In the absence of exposure to a pre-determined condition, the IUA thermochromic component is invisible (56, FIG. 7A). The product identification bar code is readable (52, FIG. 7A) and the condition detecting bar code is unreadable as it is not a complete bar code (54, FIG. 7A). After exposure to the pre-determined condition, the IUA thermochromic component becomes visible (56, FIG. 7B). The originally readable product identification bar code becomes unreadable (52, FIG. 7B) and the originally unreadable condition detecting bar code becomes a complete bar code and readable (54, FIG. 7B) to indicate the exposure to the pre-determined condition.

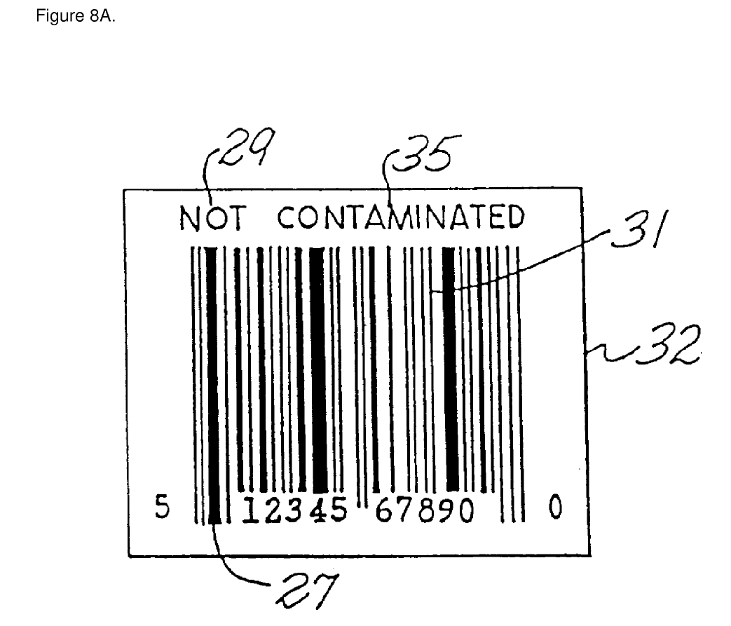

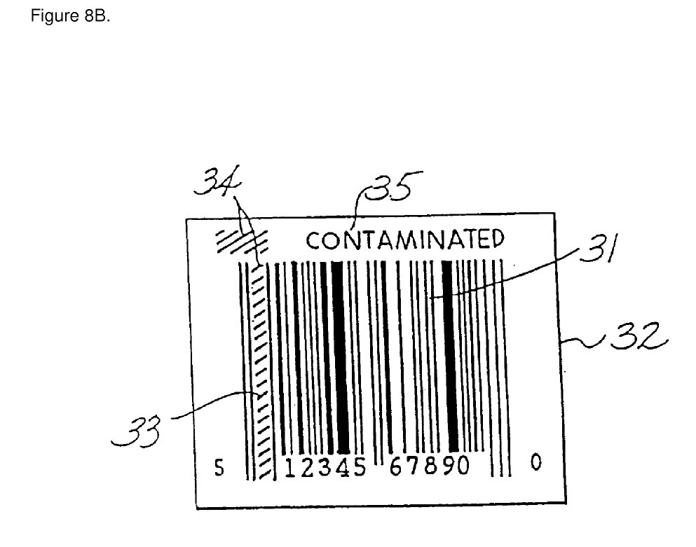

In certain embodiments, an IUA thermochromic indicator includes an IUA thermochromic indicia combining human recognized language or code and machine recognized indicia (e.g. bar code) (32, FIGS. 8A and 8B). FIG. 8A shows an IUA thermochromic indicator in the absence of a pre-determined condition. The word “NOT” (29, FIG. 8A) is prepared using an IUA thermochromic composition such that it is only readable in the absence of the pre-determined condition, and is associated with another word “CONTAMINATED” (35, FIG. 8A) to form a indicium “NOT CONTAMINATED” that is recognizable by human or detector. Substrate 27 (FIG. 8A) is prepared using an IUA thermochromic composition and aligned with the rest of a bar code (31, FIG. 8A) such that in the bard code is readable (FIG. 8A). After exposure to the pre-determined condition, substrate 29 in FIG. 8A becomes substrate 34 in FIG. 8B which is no longer visible and associated with substrate 35 becomes “CONTAMINATED.” Substrate 27 in FIG. 8A becomes substrate 33 which is invisible and renders the bar code 31 unreadable.

In certain embodiments, an IUA thermochromic indicator comprises multiple condition indicia, wherein the each condition indicia reflects an absence or presence of different or same pre-determined conditions. In certain embodiments, the predetermined conditions may also include toxin-related pre-determined condition, such as in U.S. patent application Ser. No. 11/838,727, filed on Aug. 14, 2007 and U.S. Pat. No. 5,306,466, issued on Apr. 26, 1994; No. 5,869,341, issued on Feb. 9, 1999; No. 6,190,610, issued on Feb. 20, 2001; No. 6270724, issued on Aug. 7, 2001; No. 6,479,016, issued on Nov. 12, 2002; No. 7156597, issued on Jan. 2, 2007 and No. 7157048, issued on Jan. 2, 2007, the disclosure of which is incorporated by reference herein in their entireties. In certain embodiments, an IUA thermochromic component adopts the same design as the condition indicia disclosed in the US patent application and/or the US patents referred supra.

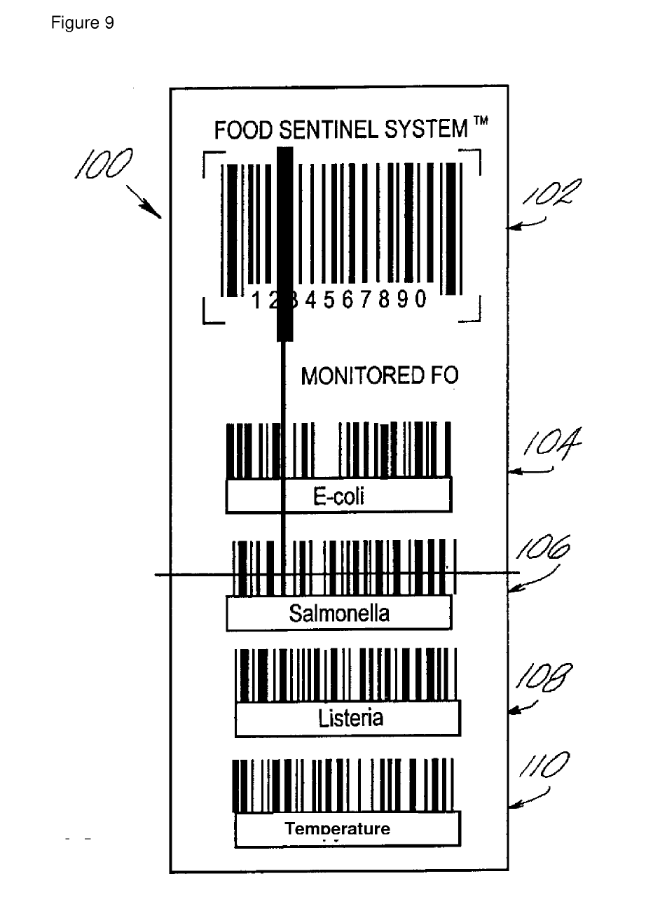

In certain embodiments, an IUA thermochromic indicator includes a multiple condition indicator such as that marketed under the Food Sentinel System™ (U.S. patent Ser. No. 09/153,565, filed Sep. 15, 1998, the disclosure of which is incorporated by reference herein in its entirety.). (100, FIG. 9). The IUA thermochromic indicator includes a first selectively-unreadable indicium (102, FIG. 9) which is initially a readable indicium in the absence of any pre-determined conditions and becomes unreadable when the indicator is exposed to any of the pre-determined conditions, e.g. E. Coli, Salmonella, Listeria or a temperature-related condition. The IUA thermochromic indicator further includes a second coded indicium 104, a third coded indicium 106, and a fourth coded indicium 108, and a fifth coded indicium 110, all of which are selectively-readable indicia and triggered by the same or different pre-determined conditions. For example, indicium 104 is triggered by the presence of E. coli, indicium 106 is triggered by the presence of Salmonella, indicium 108 is triggered by the presence of Listeria and indicium 110 is triggered by exposure to a temperature-related pre-determined condition.

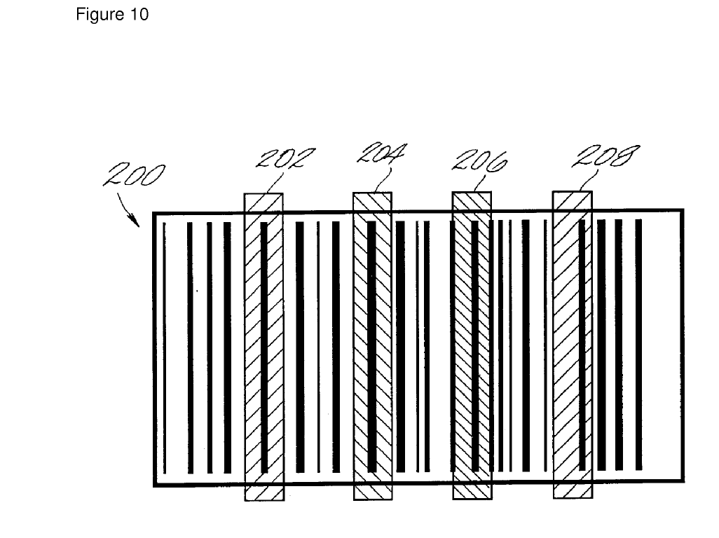

In certain embodiments, an IUA thermochromic indicator (200, FIG. 10) comprises multiple single coded condition indicia (202, 204, 206 and 208, FIG. 10). This IUA thermochromic indicator is prepared to identify more than one condition indicative of contamination in product. The IUA thermochromic indicator is a selectively-unreadable indicium comprises a readable bar code which can be printed by ordinary ink. In the absence of any pre-determined conditions, all the condition indicia are not detectable and the bar code is readable. In the presence of any one pre-determined condition, the corresponding condition indicia 202, 204, 206 or 208 will be triggered and render the originally readable bar code unreadable. At least one of the condition indicia is an IUA thermochromic component which is undetectable in the absence of a pre-determined condition and detectable upon the exposure to the pre-determined condition. In certain embodiments, more than one of the condition indicia are IUA thermochromic components wherein each IUA thermochromic component is triggered by different or the same pre-determined conditions. For example, a first IUA thermochromic component of an IUA thermochromic indicator will be triggered by exposure to 33-39° F. for more than 1 hr, a second IUA thermochromic component of the IUA thermochromic indicator will be triggered by exposure to 40-75° F. for more than 1 h and/or by exposure to 90° F. for more than 5 minutes. When the IUA thermochromic indicator is exposed to a temperature of 33-39° F. for 1 hour, the first IUA thermochromic component will be triggered but the second IUA thermochromic component will stay activated As a result, the selectively-unreadable indicia will be unreadable because one of the IUA thermochromic components is triggered, the first IUA thermochromic component will be readable as it is triggered, and the second IUA thermochromic component will remain unreadable as it is not triggered.

Each condition indicium can be spaced apart from another or be arranged in an overlapping manner, a continuous manner, or any combination thereof. In certain embodiments, an IUA thermochromic indicator incorporates one of RSS formats (e.g. stacked RSS symbology such as RSS-14 stacked and RSS expanded Stacked, RSS Limited, RSS-14 Trunctated, RSS-14 Stacked and others, as described in further detail at htpp://www.gs1.org/) as described in U.S. Patent application 2008/0043804, the disclosure of which is incorporated by reference herein in its entirety.

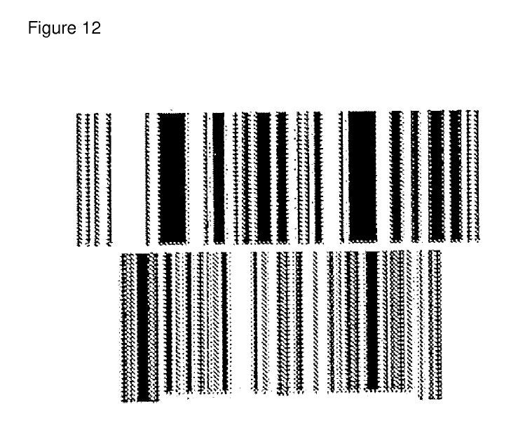

In certain embodiments, an IUA thermochromic indicator incorporates a RSS symbology which includes more than one data. For example, a CC-A code using Composite Component structures (FIG. 12).

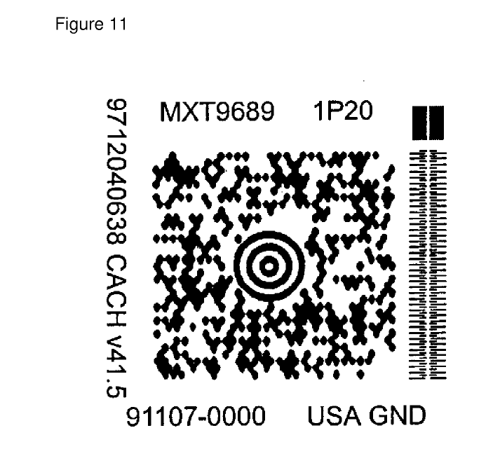

In certain embodiments, an IUA thermochromic indicator comprises a 2-dimensional code structure (FIG. 11). In certain embodiments, the 2-dimensional code (e.g. a CC structure) is an always-readable indicia. The IUA thermochromic indicator further includes a non-CC structure which is a selectively readable, selectively unreadable indicia, a plurality or a mixture thereof.

More information of Composite Component (CC) is available at http://www.aimcilobal.org. Examples of CC structures include, without limitation, CC-A, CC-B and CC-C. CC structures can also be incorporated with other symbologies such as RSS, GS1, EAN, and UPC. Examples of the combined structures include, without limitation, RSS-14 Truncated with CC-A, RSS Limited with CC-B, GS1-12B (SSCC-18) with CC-C, EAN-13 with CC-A, EAN-8 with CC-A, UPC-A with CC-B, UPC-E with CC-A, GS1-128 (SCC-14) with CC-A, and GS1-128 with CC-C.

In certain embodiments, an IUA thermochromic indicator is an article which can be applied to a subject stored in the absence of a pre-determined condition. In certain embodiments, an IUA thermochromic composition is applied to an article and activated to form an IUA thermochromic component/indicator. In certain embodiments, an IUA thermochromic composition is activated and then applied to an article to form an IUA thermochromic component/indicator. An IUA thermochromic indicator will remain activated without exposure to the pre-determined condition. When the IUA thermochromic indicator is exposed to the pre-determined condition, the IUA thermochromic composition is deactivated and such deactivation is detectable.

In certain embodiments, an IUA thermochromic indicator is an indicator on a subject which is stored below a pre-determined temperature, comprising an IUA thermochromic composition wherein the IUA thermochromic composition is activated when the subject is kept below the pre-determined temperature and deactivated when the subject is exposed to a temperature above the pre-determined temperature, and such deactivation is detectable.

In certain embodiments, a thin film of an IUA thermochromic composition is applied to cover a barcode or a portion thereof that can be read by a scanner at a pre-determined wavelength. The IUA thermochromic composition is transparent at the pre-determined wavelength when it is activated. Therefore the barcode can be read by the scanner at the pre-determined wavelength as long as the IUA thermochromic composition remains activated. When the barcode is exposed to a pre-determined condition, the IUA thermochromic composition is deactivated and absorbs at the pre-determined wavelength. The barcode can no longer be read by the scanner at the pre-determined wavelength and will be detected. In certain embodiments, a pre-determined wavelength is 650 nm. In certain embodiments, a pre-determined condition is an exposure to a temperature equal to or higher than about 5° C. below the IRTTT of the IUA thermochromic composition for more than 2 hours. In certain embodiments, a pre-determined condition is an exposure to a temperature equal to or higher than about the IRTTT of the IUA thermochromic composition for more than 15 minutes. In certain embodiments, a pre-determined condition is an exposure to a temperature equal to or higher than about 5° C. above the IRTTT of the IUA thermochromic composition.

In certain embodiments, a barcode or a portion thereof is printed using an IUA thermochromic composition as ink (IUA thermochromic ink). The IUA thermochromic ink is transparent at a pre-determined wavelength when activated therefore the barcode cannot be read by a scanner at the pre-determined wavelength. When the barcode is exposed to a pre-determined condition, the IUA thermochromic ink is deactivated and absorbs at the pre-determined wavelength. The barcode can now be read by the scanner at the pre-determined wavelength. In certain embodiments, the pre-determined wavelength is 650 nm. In certain embodiments, a pre-determined condition is an exposure to a temperature equal to or higher than about 5° C. below the IRTTT of the IUA thermochromic composition for more than 2 hours. In certain embodiments, a pre-determined condition is an exposure to a temperature equal to or higher than about the IRTTT of the IUA thermochromic composition for more than 15 minutes. In certain embodiments, a pre-determined condition is an exposure to a temperature equal to or higher than about 5° C. above the IRTTT of the IUA thermochromic composition.

In certain embodiments, an IUA thermochromic indicator can adopt a similar principles and designs as described supra wherein the IUA thermochromic component will either disappear or appear upon the exposure to a pre-determined condition.

### 4. Method of Preparation

Another aspect of the invention relates to a method of preparing an activated IUA thermochromic composition comprising converting an IUA thermochromic composition to a high temperature state and cooling the composition to a cooling temperature in a cooling time.

In certain embodiments, an IUA thermochromic composition is converted to a high temperature state by exposing the composition to a high radiant energy (e.g. UV light). In certain embodiments, an IUA thermochromic composition is converted to a high temperature state by exposure to heat.

In certain embodiments, an IUA thermochromic composition is converted to a high temperature state by being heated to a heating temperature for a time sufficient to display a high temperature color. In certain embodiments, a heating temperature is at or above a RTTT_{L}. In certain embodiments, a heating temperature is 20° C. below a RTTT of an IUA thermochromic composition. In certain embodiments, a heating temperature is a temperature at which an IUA thermochromic composition exhibits a high temperature color in less than about 1 minute. In certain embodiments, a heating temperature is between 80 and 150° C. In certain embodiments, a heating time is between 0.5 and 4 seconds.

In certain embodiments, a cooling temperature is a temperature below an IRTTT_{L} of an IUA thermochromic composition. In certain embodiments, a cooling temperature is about 5-20° C. below an IRTTT. In certain embodiments, a cooling temperature is more than 20° C. below an IRTTT of an IUA thermochromic composition. In certain embodiments, a cooling temperature is more than 30° C. below an IRTTT.

In certain embodiments, a cooling time is less than about 2 seconds. In certain embodiments, a cooling time is less than 1 second.

In certain embodiments, an IUA thermochromic composition or indicator is activated using a thermochromic ink label activator as described in patent application Ser. No. 12/428,323, filed on Apr. 22, 2009, the disclosure of which is herein incorporated by its entirety, wherein the IUA thermochromic composition or indicator is converted to a high temperature state by exposing to a radiant illumination unit (e.g. a UV or IR lamp) or a heat source (e.g. a contact hot plate or a hot air source).

Another aspect of the invention relates to a method of preparing an activated IUA thermochromic component/indicator.

In certain embodiments, a method comprises applying an activated IUA thermochromic composition to an article to be used as a thermal indicator at a temperature below the IRTTT_{L} of the IUA thermochromic composition.

In certain embodiments, a method comprises:

applying an IUA thermochromic composition to an article to be used as a thermal indicator;

converting the IUA thermochromic composition to a high temperature state; and

cooling the article and/or the IUA thermochromic composition to a cooling temperature in a cooling time.

In certain embodiments, a conversion of an IUA thermochromic composition to a high temperature state is achieved by exposing the IUA thermochromic composition to a high radiant energy (e.g. UV light). In certain embodiments, a conversion of an IUA thermochromic composition to a high temperature state is achieved by heating an article with an IUA thermochromic composition or indicator, or heating the IUA thermochromic composition to a heating temperature for a time sufficient to display a high temperature color. In certain embodiments, a heating temperature is a temperature at or above a RTTT_{L}. In certain embodiments, a heating temperature is 20° C. below a RTTT of an IUA thermochromic composition. In certain embodiments, a heating temperature is a temperature at which an IUA thermochromic composition exhibits a high temperature color in less than about 1 minute. In certain embodiments, a heating temperature is between 80 and 150° C. In certain embodiments, a heating time is between 0.5 and 4 seconds. In certain embodiments, an IUA thermochromic composition or indicator is activated using a thermochromic ink label activator as described in patent application Ser. No. 12/428,323, filed on Apr. 22, 2009, the disclosure of which is herein incorporated by its entirety, wherein the IUA thermochromic composition or indicator is converted to a high temperature state by exposing to a radiant illumination unit (e.g. a UV or IR lamp) or a heat source (e.g. a contact hot plate or a hot air source).

In certain embodiments, a cooling temperature is a temperature below an IRTTT_{L} of an IUA thermochromic composition. In certain embodiments, a cooling temperature is more than 5° C. below an IRTTT of an IUA thermochromic composition. In certain embodiments, a cooling temperature is more than 20° C. below an IRTTT of an IUA thermochromic composition. In certain embodiments, a cooling temperature is more than 30° C. below an IRTTT of an IUA thermochromic composition.

In certain embodiments, a cooling time is less than about 2 seconds. In certain embodiments, a cooling time is less than 1 second.

### 5. Method of Monitoring

Another aspect of the invention relates to a method of monitoring a subject stored in the absence of a pre-determined condition. In certain embodiments, a pre-determined condition is defined the same as supra.

In certain embodiments, a method comprises:

applying an activated IUA thermochromic composition, component or indicator on a subject that is to be stored without exposure to a pre-determined condition;

detecting the subject when the subject is or has been exposed to the pre-determined condition by detecting the deactivation of the IUA thermochromic composition, component or indicator.

In certain embodiments, the method comprises:

applying an IUA thermochromic composition, component or indicator on a subject to be stored without exposure to a pre-determined condition;

activating the IUA thermochromic composition, component or indicator;

detecting the subject when the subject has been exposed to the pre-determined condition by detecting the deactivation of the IUA thermochromic composition, component or indicator.

In certain embodiments, a thin film of an IUA thermochromic composition is applied to cover a barcode that can be read by a scanner at a pre-determined wavelength. The IUA thermochromic composition is transparent at the pre-determined wavelength when it is activated. Therefore the barcode can be read by the scanner at the pre-determined wavelength as long as the IUA thermochromic composition is kept activated. When the barcode is exposed to a pre-determined condition, the IUA thermochromic composition is deactivated and absorbs at the pre-determined wavelength. The barcode can no longer be read by the scanner at the pre-determined wavelength and will be detected. In certain embodiments, the pre-determined wavelength is 650 nm. In certain embodiments, a pre-determined condition is an exposure to a temperature equal to or higher than about 5° C. below the IRTTT of the IUA thermochromic composition for more than 2 hours. In certain embodiments, a pre-determined condition is an exposure to a temperature equal to or higher than about an IRTTT of an IUA thermochromic composition for more than 15 minutes. In certain embodiments, a pre-determined condition is an exposure to a temperature equal to or higher than about 5° C. above an IRTTT of an IUA thermochromic composition.

In certain embodiments, a barcode is printed using an IUA thermochromic composition as ink (IUA thermochromic ink). The IUA thermochromic ink is transparent at a pre-determined wavelength when activated therefore the barcode cannot be read by a scanner at the pre-determined wavelength. When the barcode is exposed to a pre-determined condition, the IUA thermochromic ink is deactivated and absorbs at the pre-determined wavelength. The barcode can now be read by the scanner at the pre-determined wavelength. In certain embodiments, the pre-determined wavelength is 650 nm. In certain embodiments, a pre-determined condition is an exposure to a temperature equal to or higher than about 5° C. below the IRTTT of the IUA thermochromic composition for more than 2 hours. In certain embodiments, a pre-determined condition is an exposure to a temperature equal to or higher than about the IRTTT_{L} of the IUA thermochromic composition for more than 15 minutes. In certain embodiments, a pre-determined condition is an exposure to a temperature equal to or higher than about 5° C. above the IRTTT of the IUA thermochromic composition.

The following examples are provided to better illustrate the claimed invention and are not to be interpreted in any way as limiting the scope of the invention. All specific compositions, materials, and methods described below, in whole or in part, fall within the scope of the invention. These specific compositions, materials, and methods are not intended to limit the invention, but merely to illustrate specific embodiments falling within the scope of the invention. One skilled in the art may develop equivalent compositions, materials, and methods without the exercise of inventive capacity and without departing from the scope of the invention. It will be understood that many variations can be made in the procedures herein described while still remaining within the bounds of the invention. It is the intention of the inventors that such variations are included within the scope of the invention.

### EXAMPLES

### 1. Preparations of Compounds Having Structure I

A compound having Structure I was prepared by polymerization of the thiophene monomers according to the following Scheme 1:

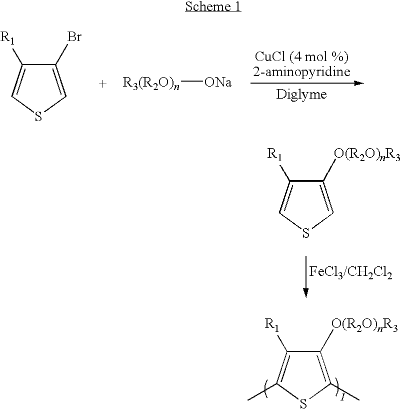

### Preparation of poly(3-methyl-4-polyoxyethylenealkylether)thiophenes (PMOET)

A PMOET was prepared according to Scheme 2.

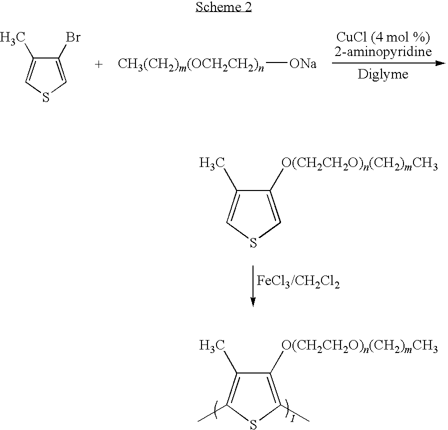

### Example 1.1 Preparation of poly-3-methyl-4-polyoxyethylene(2) stearyl ether thiophene

### PMOE-2-SET

PMOE-2-SET was prepared according to Scheme 2, wherein the average of m was 17 and the average of n was 2.

Under positive nitrogen atmosphere, polyoxyethylene (2) stearyl ether (OE-2-SE, a mixture of compounds having the average molecular structure of C₁₈H₃₇(OCH₂CH₂)₂—OH, Wako Chemicals, 152 g, 0.424 mol) and metal sodium (9.1 g, 0.395 mol) were charged into a 500 mL flask and stirred at about 120° C. until the sodium disappeared (about 2 days) to obtain the sodium salt having the average molecular structure of C₁₈H₃₇(OCH₂CH₂)₂—ONa. Under nitrogen atmosphere, 3-bromo-4-methylthiophene (50 g, 0.28 mol), diglyme (120 mL), copper chloride (0.70 g, 0.007 mol) and 2-aminopyridine (0.56 g, 0.006 mol) were charged into a 250 mL flask and stirred at room temperature for 10 minutes. Then the said mixture was added into C₁₈H₃₇(OCH₂CH₂)₂—ONa and stirred at 100° C. for about 2 days. The reaction was cooled to room temperature, filtered and rinsed with methylene chloride (300 mL) after the reaction was complete. The filtrate was purified on silica gel using ethyl acetate to elute the crude product (500 mL). The eluate was washed by dilute hydrochloric acid (50 mL×3), water (50 mL×2), dilute sodium hydroxide (50 mL×3) and saturated sodium chloride (50 mL). The washed eluate was dried and evaporated to remove unreacted 3-bromo-4-methylthiophene. The purified 3-methyl-4-polyoxyethylene(2) stearyl ether thiophene monomer (MOE-2-SET) was obtained with 50% yield.

Under nitrogen atmosphere, MOE-2-SET monomer (158 g, 0.348 mol, in 250 mL methylene chloride) was transferred into a 2 L flask containing iron trichloride (113 g, 0.696 mol) and methylene chloride (200 mL). The mixture was stirred at room temperature for about 24 hours and precipitated with cold methanol. The resulting polymer was filtered on a Buchner funnel and stirred in methanol with NaOH (300 mL, 1 g). The polymer was recollected, washed with cold methanol and warm methanol and dried to obtain poly(3-methyl-4-dioxyethylenealkylether)thiophenes (PMOE-2-SET) (54 g, yield: 34%).

### Example 1.2 Preparation of poly-3-methyl-4-polyoxyethylene(4) lauryl ether thiophene

### PMOE-4-LET

PMOE-4-LET was prepared according to Scheme 2, wherein the average of m was 11 and the average of n was 4.

### Preparation of Copolymers

Monomers of a copolymer were prepared as described supra. Copolymers were prepared by known polymerization methods. The term “copolymer” and “copolymers” as used herein means polymers that have more than one monomer. For example, a copolymer can be an alternating copolymer (with different monomers arranged in an alternating sequence), a periodic copolymer (with different monomers arranged in a repeating sequence), a random copolymer (with random sequences of different monomers) and a block copolymer (with two or more homopolymer subunits linked by covalent bonds).

### Example 1.3 Preparation of 50:50 MOE-2-SET:MOE-4-LET Copolymer-1

MOE-2-SET and MOE-4-LET were prepared as described supra. Copolymer-1 was prepared by polymerizing a monomer mixture containing 50:50 MOE-2-SET: MOE-4-LET as described supra.

### Example 1.4 Preparation of 25:75 MOE-2-SET:MOE-4-LET Copolymer-2

MOE-2-SET and MOE-4-LET were prepared as described supra. Copolymer-1 was prepared by polymerizing a monomer mixture containing 25:75 MOE-2-SET: MOE-4-LET as described supra.

### Example 1.5 Preparation of 75:25 MOE-2-SET:MOE-4-LET Copolymer-3

MOE-2-SET and MOE-4-LET were prepared as described supra. Copolymer-1 was prepared by polymerizing of a monomer mixture containing 75:25 MOE-2-SET: MOE-4-LET as described supra.

### 2. Spectroscopic Analysis of Polythiophene.

Reflection spectra were measured with an Ocean Optics S2000 instrument using a cylindrical fiber-optic reflection probe containing one source fiber and seven collection fibers. The spectra were referenced against a white standard between 450 and 800 nm and a tungsten-halogen lamp. The samples for variable temperature spectra were prepared by drip-coating a polythiophene composition (saturated in THF) onto a piece of paper and then evaporating the solvent off with a heat gun. The samples were placed on an aluminum block containing a thermometer and placed on a hot plate, which was used to heat the sample at about 2° C./minute. Removal of the heat source gave a similar cooling rate. The surface temperature at the sample site was calibrated by using the reflection change associated with the melting of biphenyl (69° C.) and naphthalene (80° C.). Variable temperature reflection spectra were measured at 600 nm from around −40° C. to around 120° C. Transition temperatures of the sample compounds or compositions were determined by the center of the sigmoid curve. In order for an activated IUA thermochromic composition to remain activated, the composition should be kept below the IRTTT_{L}.

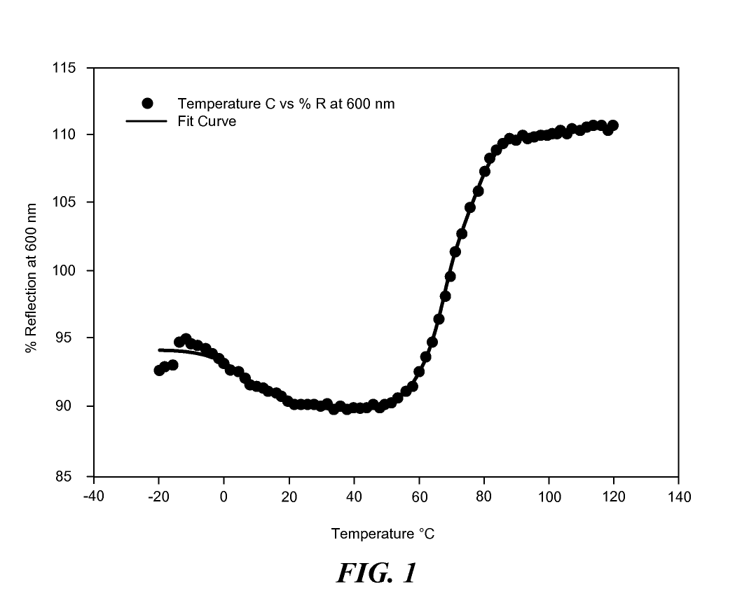

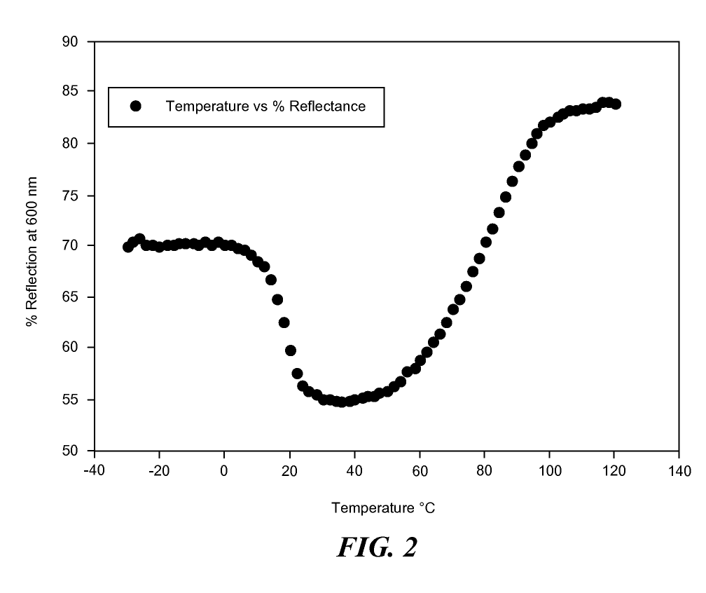

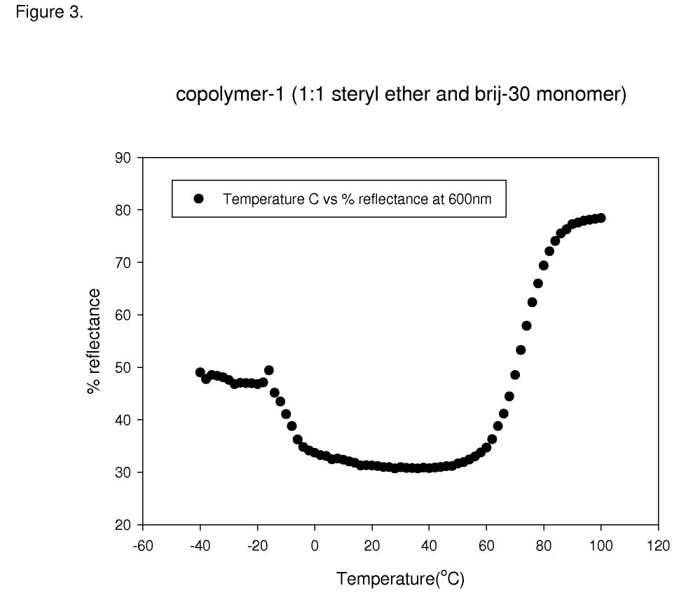

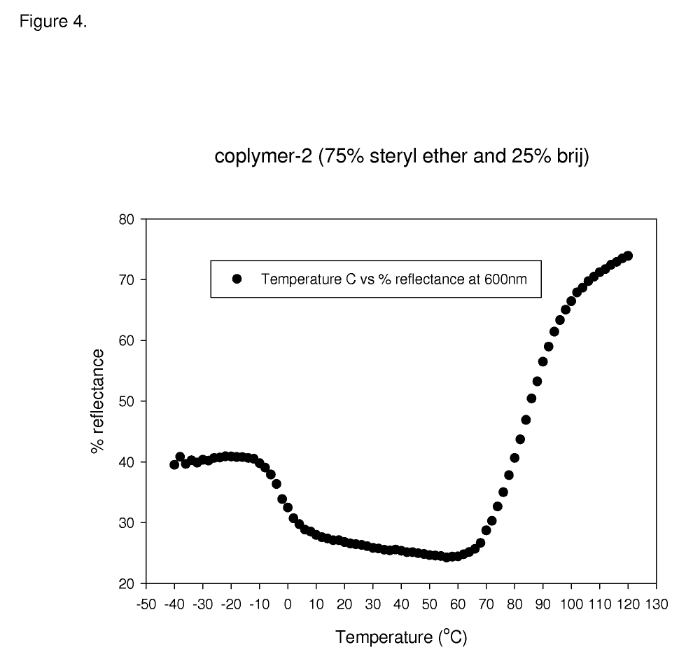

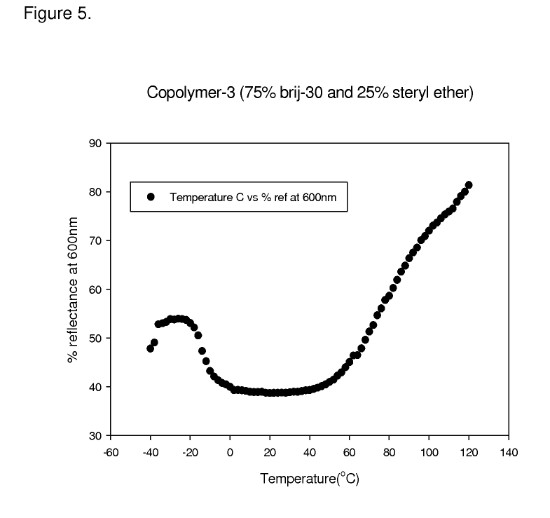

Variable temperature reflection spectra at 600 nm of PMOE-4-LET (FIG. 1), PMOE-2-SET (FIG. 2), 50:50 MOE-2-SET:MOE-4-LET Copolymer-1 (FIG. 3), 25:75 MOE-2-SET: MOE-4-LET Copolymer-2 (FIG. 4), and 50:50 MOE-2-SET: MOE-4-LET Copolymer-3 (FIG. 5). The transition temperatures were determined as the center of the sigmoid of the curve (Table 1).

TABLE 1

| | | | Irreversible | Reversible | |
|---|---|---|---|---|---|
| | | | transition | transition | |
| | % MOE-2- | % MOE-4- | temperature | temperature | |
| Samples | SET | LET | (IRTTT) | (RTTT) | IRTTT_{L} |
| PMOE-4- | 0 | 100 | 5° C. | 70° C. | −12° C. (0° F.). |
| LET | | | | | |
| PMOE-2- | 100 | 0 | 18° C. | 75° C. | 5° C. (40° F.). |
| SET | | | | | |
| Copolymer-1 | 50 | 50 | −18° C. | 65° C. | −23° C. |
| Coplymer-2 | 75 | 25 | −6° C. | 68° C. | −11° C. |
| Copolymer-3 | 25 | 75 | −20° C. | 60° C. | −25° C. |

3. IUA thermochromic indicator and detecting of subjects that has been exposed to a temperature exceeds a pre-determined temperature.

### Example 3.1 Barcode Coated with PMOE-2-SET

Barcodes were coated with a thin film of a composition comprising PMOE-2-SET. When the composition was in the activated phase the pigments were transparent at 650 nm and the bar code was detectable by a scanner. When the activated composition reached or exceeded the IRTTT, the composition reverted to a thermodynamic low temperature phase at which it absorbed at 650 nm, and the bar codes were no longer readable by the scanner.

Barcodes were coated with pure PMOE-2-SET wherein the PMOE-2-SET was activated and stored in a refrigerator at 40° F. for 8 week. Periodic scanning confirmed that the activated phase of the 40° F. pigment was retained during the entire 8 weeks. When the card sock samples (without any cold mass) were removed from the refrigerator, the IUA thermochromic transition occurred in about 20 minutes and the bar codes could no longer be scanned.

### Example 3.2 Barcode Coated with PMOE-4-LET

Barcodes were coated with a thin film of a composition comprising PMOE-4-LET. When the composition was in the activated phase the pigments were transparent at 650 nm and the bar code was detectable by a scanner. When the activated composition reached or exceeded the IRTTT, the composition reverted to a thermodynamic low temperature phase at which it absorbed at 650 nm, and the bar codes were no longer readable by the scanner.

### Example 3.3

### An IUA Thermochromic Indicator Adopting Purveyor's Bar Code Structure

An IUA thermochromic indicator comprises a complete bar code (such as a purveyor's bar code) and an incomplete bar code (FIG. 6A) using an ordinary ink. The IUA thermochromic indicator further comprises an IUA thermochromic component prepared using an IUA thermochromic composition (e.g. PMOE-4-LET and PMOE-2-SET or copolymer of MOE-4-LET and MOE-2-SET). The IUA thermochromic component is activated as described supra and is invisible under a pre-determined wavelength (e.g. 650 nm). When the IUA thermochromic indicator is exposed to a pre-determined condition, the IUA thermochromic component is deactivated and is associated with the complete bar code and/or the incomplete bar code such that the deactivated IUA thermochromic composition is visible under a pre-determined wavelength (e.g. 650 nm) and renders the complete bar code unreadable and/or complete the incomplete code to be readable (FIG. 6B).

### Example 3.4

### An IUA Thermochromic Indicator Adopting a GILBAR™ Structure

An IUA thermochromic indicator is prepared adopting a GILBAR™ structure using an ordinary ink (FIG. 7A). The GILBAR™ bar code comprises a readable code (52, FIG. 7A) and an incomplete code (54, FIG. 7A). The IUA thermochromic indicator further comprises an IUA thermochromic component prepared using an IUA thermochromic composition (e.g. PMOE-4-LET and PMOE-2-SET or copolymer of MOE-4-LET and MOE-2-SET) (56, FIG. 7A). The IUA thermochromic component is associated with the bar codes 52 and 54 such that in the absent of a pre-determined condition (e.g. exposed to a pre-determined temperature/temperature range for a pre-determined time period), the activated IUA thermochromic composition is invisible under a pre-determined wavelength (e.g. 650 nm) therefore the IUA thermochromic component is invisible under the pre-determined wavelength. After exposure to the pre-determined condition, the activated IUA thermochromic composition is deactivated and becomes visible under the pre-determined wavelength, therefore the IUA thermochromic component becomes visible under the pre-determined wavelength (56, FIG. 7B). The IUA thermochromic component is associated with the bar codes 52 and 54 such that the originally readable bar code 52 is no longer readable and the originally incomplete bar code 54 is not complete and readable.

### Example 3.5

### An IUA Thermochromic Indicator Combining a Human Readable Code and Machine Readable Code

An IUA thermochromic indicator (32, FIG. 8A) comprising human readable indicia (29 and 35, FIG. 8A) and machine readable indicia (27 and 31, FIG. 8A). Indicia 35 and 31 are printed with ordinary ink. Indicia 29 and 27 are printed with an IUA thermochromic ink. The IUA thermochromic ink is visible in the absence of a pre-determined condition, and becomes invisible upon exposure to the pre-determined condition. In the absence of the pre-determined condition, indicia 29 and 35 together show “NOT CONTAMINATED” which is recognizable by human; indicia 27 and 31 together form a machine readable indicium. After exposure to the pre-determined condition, indicia 29 and 27 in FIG. 8A becomes invisible indicia 34 and 33 in FIG. 8B respectively. Indicia 34 and 35 together show “CONTAMINATED” which is recognizable by human, and indicia 33 and 31 together form a bar code that is no longer machine readable.

### Example 3.6

### An IUA Thermochromic Indicator Comprising Multiple Condition Indicia (I)

An IUA thermochromic indicator includes multiple condition indicia such as that marketed under the Food Sentinel System™ (100, FIG. 9). The IUA thermochromic indicator includes a first selectively-unreadable indicium (102, FIG. 9) which is initially a readable indicium in the absence of any pre-determined conditions and becomes unreadable when the indicator is exposed to any of the pre-determined conditions, e.g. E. Coli, Salmonella, Listeria and a temperature-related condition. The IUA thermochromic indicator further includes a second coded indicium 104, a third coded indicium 106, and a fourth coded indicium 108, and a fifth coded indicium 110, all of which are selectively-readable indicia and triggered by the same or different pre-determined conditions. For example, indicium 104 is triggered by the presence of E. coli, indicium 106 is triggered by the presence of Salmonella, indicium 108 is triggered by the presence of Listeria and indicium 110 is triggered by exposure to a temperature-related pre-determined condition.

### Example 3.7

### An IUA Thermochromic Indicator Comprising Multiple Condition Indicia (II)

An IUA thermochromic indicator (200, FIG. 10) comprises multiple single coded condition indicia (202, 204, 206 and 208, FIG. 10) is prepared to identify more than one condition indicative of contamination in product. The IUA thermochromic indicator is a selectively-unreadable indicium wherein in the absence of any pre-determined conditions, all the condition indicia are not detectable and the IUA thermochromic indicator is readable. In the presence of any pre-determined condition, the corresponding condition indicia 202, 204, 206 or 208 will be triggered and render the originally readable code unreadable. At least one of the condition indicia is an IUA thermochromic component which is undetectable in the absence of a pre-determined condition and detectable upon the exposure to the pre-determined condition.

1. A polythiophene compound having the following chemical structure: 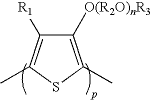
including stereoisomers thereof, wherein:
each R₁ of each monomer is independently selected from the group consisting of H and alkyl radical;
each R₂ of each monomer is independently selected from the group consisting of alkyl radical and alkoxyl radical;
each R₃ of each monomer is independently selected from the group consisting of alkyl radical and alkoxyl radical;
each n of each monomer is an independently selected integer; and
p is 2-1000.

2. The compound according to claim 1, wherein R₁ is CH₃.

3. The compound according to claim 2, wherein:
R₃ is CₘH₂ₘ₊₁, wherein m of each monomer is an independently selected integer;
the average of m of all monomers is 7 to 21;
the average of n of all monomers is 0 to 6; and
3n+m+1 is 20 to 40.

4. The compound according to claim 3, wherein
R₂ is CH₂CH₂;
m is 17 or 11;
when m is 11, the average of n is 4 (monomer MOE-4-LET); and
when m is 17, the average of n is 2 (monomer MOE-2-SET).

5. A composition comprising a compound according to claim 1.

6. The composition according to claim 5, further comprising a carrier medium.

7. The composition according to claim 5, wherein R₁ is CH₃.

8. The composition according to claim 7, wherein:
R₃ is CₘH₂ₘ₊₁, wherein m of each monomer is an independently selected integer;
the average of m of all monomers for each polythiophene compound is 7 to 21;
The average of n of all monomers for each polythiophene compound is 0 to 6; and
3n+m+1 is 20 to 40.

9. The composition according to claim 8, wherein R₂ is CH₂CH₂.

10. The composition according to claim 9, wherein the monomers are selected from the group consisting of MOE-2-SET and MOE-4-LET as defined in claim 4.

11. The composition according to claim 6, wherein the carrier medium is an ink formulation, poly(ethylene terephthalate)s (PET), polysytrenes, polyolefins including polyethylenes (HDPE and LDPE) and polypropylene, polycarbonates, polyacrylics, polyacrylic acids, polyacrylamides, polymethacrylics, polyvinyl ethers, polyvinyl halides, poly(vinyl nitrile)s, polyvinyl esters, polyesters, polysofones, polysulfonamides, polyamides, polyimines, polyimides, and carbohydrates.

12. The composition according to claim 11, wherein the ink formulation comprises oils, resins, pigment extenders and additives.

13. The composition according to claim 6, wherein the concentration of the compound in the composition is about 0.05% to about 99.5% by weight.

14. The composition according to claim 6, wherein the concentration of the compound in the composition is about 10% by weight.

15. An irreversible upon activation (IUA) thermochromic composition comprising a composition according to claim 5, wherein the composition has an irreversible thermochromic transition temperature (IRTTT) and a low irreversible thermochromic transition temperature (IRTTT_{L}).

16. The IUA thermochromic composition according to claim 15 wherein the IRTTT is between about −30° C. to about 60° C.

17. The IUA thermochromic composition according to claim 15, wherein the IUA composition is selected from the group consisting of a polymer composition of MOE-4-LET having an IRTTT of 5° C., a polymer composition of MOE-2-SET having an IRTTT of 18° C., a copolymer composition of 50:50 MOE-4-LET:MOE-2-SET having an IRTTT of −18° C., a copolymer composition of 75:50 MOE-4-LET:MOE-2-SET having an IRTTT of −6° C., and a copolymer composition of 25:75 MOE-4-LET:MOE-2-SET having an IRTTT of −20° C.

18. The IUA thermochromic composition according to claim 15, wherein an activated IUA thermochromic composition has a first set of optical properties, an deactivated IUA thermochromic composition has a second set of optical properties, wherein the two sets of optical properties are not identical, and the difference or differences between the two sets of optical properties can be recognized by a human eye or a detecting device.

19. The IUA thermochromic composition according to claim 18, wherein the activated IUA thermochromic composition is transparent under a pre-determined wavelength, and the deactivated IUA thermochromic composition is not transparent under the pre-determined wavelength.

20. An activated IUA thermochromic composition comprising an IUA thermochromic composition according to claim 15, wherein:
the IUA thermochromic composition is activated by heating the IUA thermochromic composition to a heating temperature for a time sufficient to exhibit a high temperature color to convert the IUA thermochromic composition to a high temperature state; and
cooling the IUA thermochromic composition to a cooling temperature in less than 2 seconds.

21. The activated IUA thermochromic composition according to claim 20, wherein the cooling temperature is about 5-20° C. below an IRTTT of the IUA thermochromic composition.

22. The activated IUA thermochromic composition according to claim 20, wherein the cooling temperature is more than 20° C. below an IRTTT of the IUA thermochromic composition.

23. The activated IUA thermochromic composition according to claim 20, wherein the IUA thermochromic composition is cooled to the cooling temperature in less than 1 second.

24. An irreversible upon activation (IUA) thermochromic indicator comprising an IUA thermochromic component prepared using an IUA thermochromic composition according to claim 15.

25. The IUA thermochromic indicator according to claim 24, wherein the IUA thermochromic component is a selectively-readable indicium by itself, and/or by associating with other component(s) of the IUA thermochromic indicator, the IUA thermochromic component is activated and non-readable in the absence of a pre-determined condition and becomes deactivated and readable upon exposure to the pre-determined condition.

26. The IUA thermochromic indicator according to claim 24, wherein the IUA thermochromic component is a selectively-non-readable indicium by itself and/or by associating with other component(s) of the IUA thermochromic indicator, the IUA thermochromic component is activated and readable in the absence of a pre-determined condition and becomes deactivated and non-readable upon exposure to the pre-determined condition.

27. The IUA thermochromic indicator according to claim 24, further comprising one or more indicia that are independently selected from the group consisting of always-readable indicia, selectively-readable indicia, selectively-unreadable indicia, a plurality and a mixture thereof.

28. The IUA thermochromic indicator according to claim 27, wherein each component can be triggered upon exposure to the same or different pre-determined conditions, wherein the pre-determined condition that triggers the IUA thermochromic component is exposure to a pre-determined temperature for a pre-determined period of time.

29. The IUA thermochromic indicator according to claim 28, wherein the pre-determined temperature is +/−0-10° C. of an IRTTT of the IUA thermochromic composition used to prepare the IUA thermochromic component; and the pre-determined period of time is selected from 1 second to 20 hours.

30. The method according to claim 29, wherein the IRTTT of the IUA thermochromic composition is between about −30° C. to about 60° C.

31. The method according to claim 29, wherein the IRTTT of the IUA thermochromic composition is about −20° C., −18° C., −12° C., −6° C., 5° C. or 18° C.

32. The IUA thermochromic indicator according to claim 25, comprising an indicium printed by an activated IUA thermochromic composition according to claim 24, wherein the indicium is non-readable in the absence of a pre-determined condition and becomes readable upon exposure to the pre-determined condition.

33. The IUA thermochromic indicator according to claim 26, comprising an readable indicium, wherein part or the whole of the indicium is coated with an activated IUA thermochromic composition according to claim 24, wherein the indicium is readable in the absence of a pre-determined condition and becomes non-readable upon exposure to the pre-determined condition.

34. A method of preparing an activated IUA thermochromic composition comprising:
heating an IUA thermochromic composition according to claim 15 to a heating temperature for a time sufficient to exhibit a high temperature color to convert the IUA thermochromic composition to a high temperature state; and
cooling the IUA thermochromic composition to a cooling temperature in less than 2 seconds.

35. The method according to claim 34, wherein the cooling temperature is about 5-20° C. below an IRTTT of the IUA thermochromic composition.

36. The method according to claim 34, wherein the cooling temperature is more than 20° C. below an IRTTT of the IUA thermochromic composition.

37. The method according to claim 34, wherein the IUA thermochromic composition is cooled to the cooling temperature in less than 1 second.

38. A method of preparing an IUA thermochromic indicator comprising applying an activated IUA thermochromic composition according to claim 20 to an article under a condition that the activated IUA thermochromic composition remains activated.

39. A method of preparing an IUA thermochromic indicator comprising applying an IUA thermochromic composition according to claim 20 to an article, and then activating the IUA thermochromic composition.

40. The method according to claim 39, wherein the activating step comprises:
heating the IUA thermochromic composition to a heating temperature for a time sufficient to exhibit a high temperature color to convert the IUA thermochromic composition to a high temperature state; and
cooling the article or the IUA thermochromic composition to a cooling temperature in less than 2 seconds.

41. The method according to claim 40, wherein the cooling temperature is about 5-20° C. below an IRTTT of the IUA thermochromic composition.

42. The method according to claim 40, wherein the cooling temperature is more than 20° C. below an IRTTT of the IUA thermochromic composition.

43. The method according to claim 40, wherein the article or the IUA thermochromic composition is cooled to the cooling temperature in less than 1 second.

44. A method of monitoring a subject which is to be stored without exposure to a pre-determined condition comprising:
applying an IUA thermochromic indicator according to claim 24 on the subject, wherein the IUA thermochromic indicator is already activated or will be activated without spoiling the subject;
the activated IUA thermochromic indicator will be deactivated upon exposure to the pre-determined condition;
detecting the deactivated IUA thermochromic indicator.

45. The method according to claim 44 wherein the pre-determined condition is exposure to a pre-determined temperature for a pre-determined time.

46. The method according to claim 45, wherein the pre-determined temperature is +/−0-10° C. of an IRTTT of an IUA thermochromic composition used to prepare the IUA thermochromic indicator; and the pre-determined period of time is selected from 1 second to 20 hours.

47. The method according to claim 46, wherein the IRTTT is between about −30° C. to about 60° C.

48. The method according to claim 46, wherein the IRTTT is about −20° C., −18° C., −12° C., −6° C., 5° C. or 18° C.
